(19) United States
(12) Patent Application Publication
(10) Pub. No.: US 2010/0301800 A1
(43) Pub. Date: Dec. 2, 2010

(54) Multi-purpose battery jump starter and reconditioner

(76) Inventor: Mathew Inskeep, Boca Raton, FL (US)

Correspondence Address: MCHALE & SLAVIN, P.A., 2855 PGA BLVD, PALM BEACH GARDENS, FL, 33410, US

(21) Appl. No.: 12/788,040

(22) Filed: May 26, 2010

Related U.S. Application Data
(60) Provisional application No. 61/181,107, filed on May 26, 2009.

(51) Int. Cl. H02J 7/14

(52) U.S. Cl. 320/105

(57) ABSTRACT

A multi-purpose battery jump starter and reconditioner. The device is portable and includes electronic circuitry for use in desulfating lead-acid batteries. A rechargeable internal battery permits operation in remote conditions. Accessories include an air compressor, DC outlet, USB outlet, and light to cause cycling of the battery for optimum life. The jump starter, cables and air compressor are all integrated into a light weight compact housing.

### PRIORITY CLAIM

This application claims the filing date of U.S. Provisional Patent Application No. 61/181,107, filed May 26, 2010, the contents of which is incorporated herein by reference.

### FIELD OF THE INVENTION

This invention relates generally to emergency devices for boosting the power of a battery for use in jump starting an internal combustion engine and, in particular, to a portable battery booster for jump starting an engine and for desulfating of a battery.

### BACKGROUND OF THE INVENTION

A characteristic of liquid electrolyte type batteries, particularly lead acid batteries, is that chemical compound deposits slowly build up on the plates to partially or entirely cover and displace the normal, plate surfaces. Low current recharging is inadequate in that it cannot, as such, sufficiently remove such deposits that with the passage of time crystallize and choke the battery plates by interfering with electrolyte movement. When this occurs a battery may still appear to have taken a charge and even the electrolyte may check as being correct, but the battery does not hold the charge because the plates are effectively shorted. Batteries using other electrolytes also face reclaiming, maintenance and charging problems that need to be successfully addressed.

It is known that a method of reversing the build-up of sulfur crystals on the collectors (plates) of a lead-acid type storage battery is by electrically pulsing the battery at a resonant frequency allowing the molecules to dissolve back into the electrolyte solution from which they first came. Battery conditioners known in the prior art include the use of a transformer oscillator circuit to generate the required pulse but these devices are not capable of charging or jump starting a battery in the required manner to ensure a fully charged battery, without ever overcharging said battery. There are patented techniques to reduce sulfation of lead-acid battery plates which employ pulse techniques. A fast rise time pulse is developed and pulses the battery. See U.S. Pat. Nos. 4,871,959; 5,084,664; 5,276,393 and 5,491,399. All of the techniques rely on a fast pulse developed by a transformer oscillator circuit and specifically include all types of transformer oscillators, these units are not battery chargers or jump starters.

Multi-stage battery chargers such as that disclosed in U.S. Pat. Nos. 6,184,650 and 6,586,913 are known to fully charge the battery (13.8 volts) as well as maintain the battery at a fully charged level (13.2 volts) for indefinite periods, without ever overcharging it. Such chargers may also be used to reverse the build-up of crystallized sulfur on the “plates” of a lead-acid storage battery, thereby improving the charge/discharge characteristics of a battery in which such formations have occurred, by rapidly turning the charger on and off and by generating pulses during the “float” charge cycle. When used with a battery charger, the charger is connected to a battery which begins the charge cycle. Once the battery voltage reaches 13.8 volts, the charger enters into a float mode of operation to prevent the battery voltage from going below 13 volts. In a heavily sulfated battery the voltage will drop below 13 volts and the charger will turn on to try to charge the battery. The battery charger is rapidly turned on and off with a rise time about 300 nsec and current of about 1000 ma. As the sulfation decreases, less energy is required, and the current decreases to zero at 13 volts. This means that the voltage cannot rise above 13 volts and the electrolyte will not boil away.

There are times when conventional battery charging is not feasible. Unique to the use of vehicles having internal combustion engines is that once the engine is started, the engine includes a generator or alternator capable of charging the battery. Thus, in many instances the engine battery need only have enough power to turn over the engine, a process commonly referred to as jump starting. For instance, should a consumer leave the lights of an automobile on without the engine running, the battery can be drained to a point of exhaustion within a short period of time. In such instances, the use of a jump starter can be used wherein a high current output is provided for a short duration of time. The jump starter will have its own battery allowing portability and ease of use. The jump starter may be a professional version for use by AAA or the like roadside service, or a consumer version where the life of the storage battery is critical as the device may not be recharged on a regular basis. Jump starters are also known in the art. U.S. Pat. No. 5,077,513 taught a wheeled cart containing a source battery and battery charger; U.S. Pat. No. 4,902,955 taught a wheeled jump starter with special provisions for preventing entanglement of jumper cables and having an air compressor for pressurizing car wheels; U.S. Pat. No. 4,215,306 taught a mobile jump starter having an electrical test probe system for detecting electrical shorts in vehicles.

Discloses is a multipurpose jump starter capable of battery boost, further capable of releasing the deposits that are built up on the plate surfaces, includes an emergency light, a USB powered port, and a 12 DC powered port.

### SUMMARY OF THE INVENTION

The present invention is a portable battery jump starter combined with a control circuit that can desulfate a battery and provide accessories such including compressed air, USB power port, 12 DC power port, reverse voltage detection, and emergency lighting.

An objective of the present invention is to provide a multifunction jump starter that is light weight, portable, rechargeable, and can be used for desulfating batteries.

Another objective of the invention is to provide a multifunction jump starter that ensures that an internal battery is kept in peak condition through a monitoring system and by incorporating multiple accessories to assure the device is periodically used and maintained in peak operating condition.

Still another objective is to provide an apparatus capable of oscillating pulses to produce desulfation of a battery.

A further objective is to provide an apparatus wherein the battery voltage cannot rise above a predetermined level so that battery electrolyte will not boil.

Yet another objective of the present invention is the provision of an apparatus which does not require the use of high power pulse generators or complex electronic control circuits to generate high amplitude pulses.

Another objective of the present invention is to provide a jump starter that has a compact low profile housing that allows for ease of storage in most any size vehicle trunk.

Still another objective of the invention is to provide an accessory port that allows recharging of a vehicle battery through a conventional vehicle cigarette port.

Other objectives and advantages of this invention will become apparent from the following description taken in conjunction with the accompanying drawings wherein are set forth, by way of illustration and example, certain embodiments of this invention. The drawings constitute a part of this specification and include exemplary embodiments of the present invention and illustrate various objects and features thereof.

### BRIEF DESCRIPTION OF THE DRAWINGS

FIG. 1 is a block diagram of the jump start/sulfated battery electrical interconnects;

FIG. 2 is an illustration of the graphic display panel;

FIG. 3 is an electrical schematic of the instant invention;

FIG. 4 is a front view of the assembly;

FIG. 5 is a rear view of the assembly; and

FIG. 6 is a side view of the assembly.

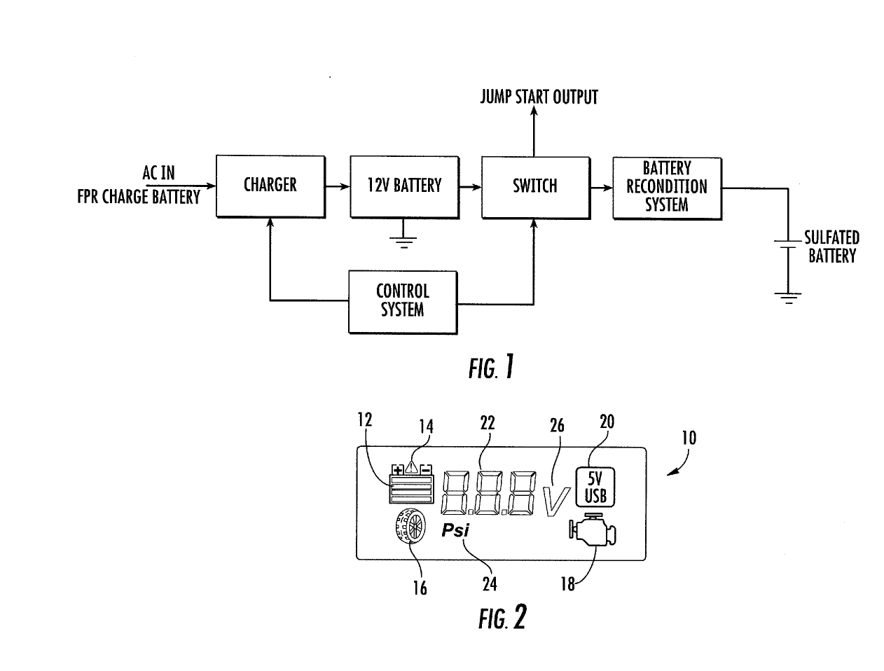

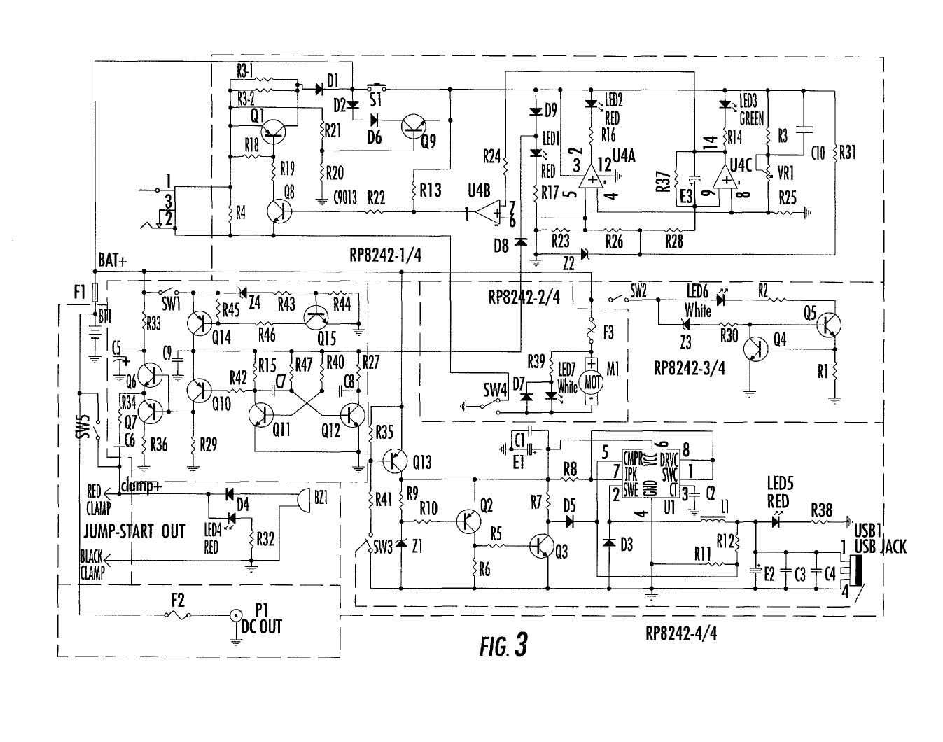

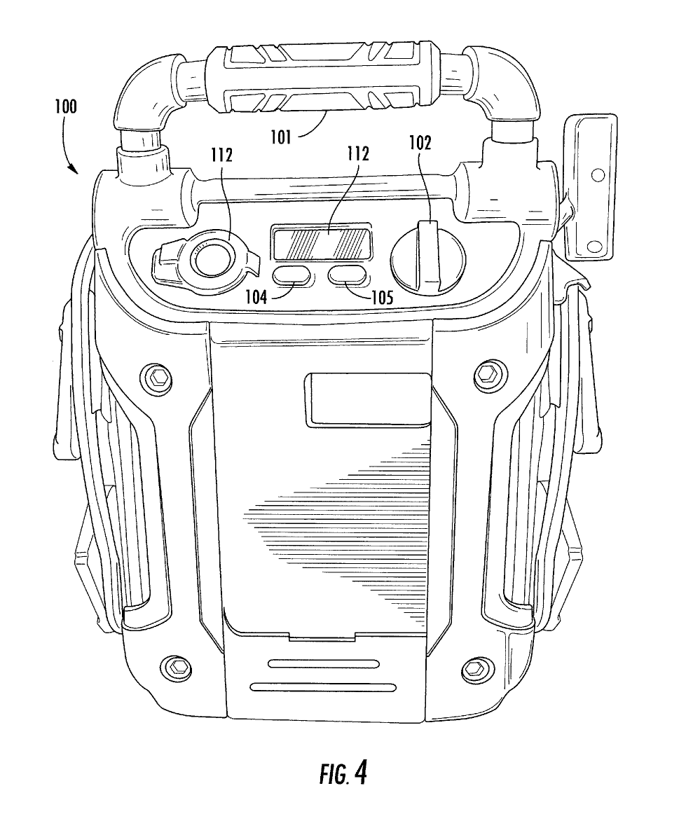

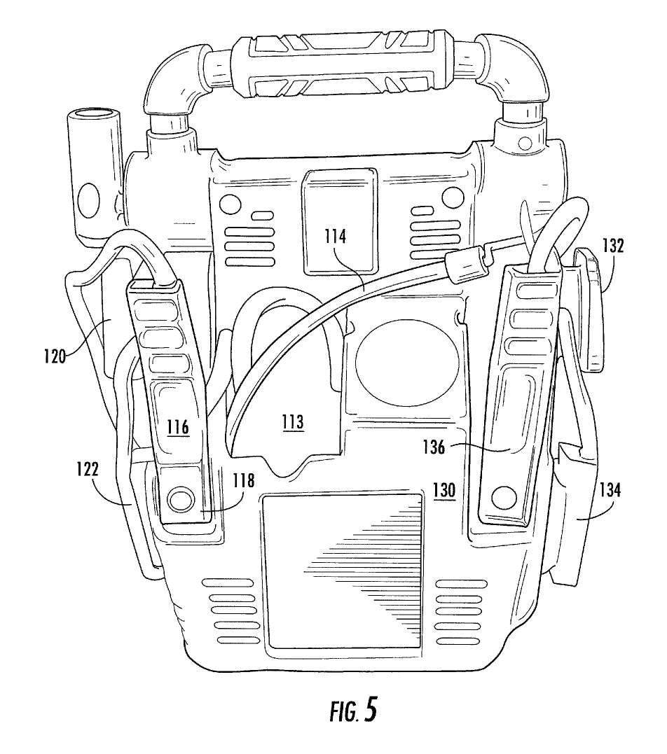

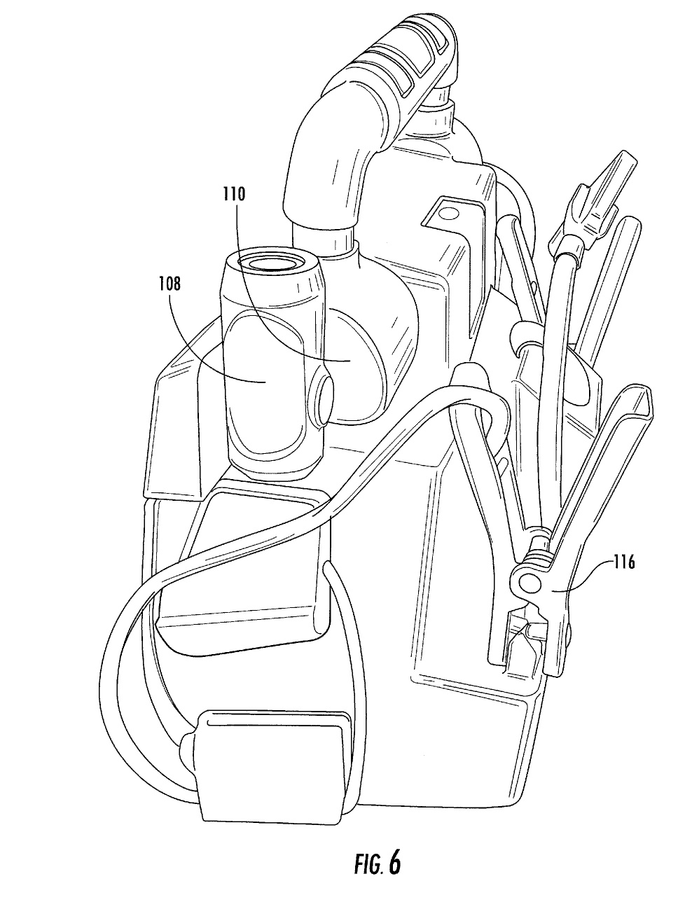

### DESCRIPTION OF THE PREFERRED EMBODIMENT

Although the invention will be described in terms of a specific embodiment, it will be readily apparent to those skilled in this art that various modifications, rearrangements and substitutions can be made without departing from the spirit of the invention. The scope of the invention is defined by the claims appended hereto.

The present invention is a multipurpose jump starter having provisions to desulfate a battery. Sulfation of a battery begins when a lead-acid battery discharges. Lead sulfate, an insulator, begins to build up on the battery's internal plates which reduces the ability of the battery to hold a full charge. When the battery has an immediate charge, most of the lead sulfate is dissolved and the plates are free of this insulation. If a battery remains in a discharged condition over a longer period of time, the lead sulfate changes to a hard crystalline form, making a full charge difficult to achieve. By use of a desulfation technique, the battery can be reconditioned to remedy this condition in most situations.

The apparatus is lightweight and portable, allowing the device to be placed in the trunk of an automobile for emergency use. In one embodiment, a boost ampere of 500 amps with 500 A instantaneous-on, 5 seconds 300 A-off, 12 VDC. An internal battery is employed, capable maintaining a charge for at least 120 days. Battery jumper cables are provide for ease of coupling to an external battery. The apparatus includes multiple accessories to include more frequent use of the device, thereby maintaining the storage battery in peak condition. Additional accessories include the use of a USB power port, a 12 DC power port, an emergency light, and an air compressor. The 12 DC power port can be used to recharge a vehicle from the inside of a vehicle. The air compressor can be used for filing of a low tire or other inflatable object. The accessories allow the device to provide multiple functions to assure safe starting of a vehicle battery and further provide a device that can be used in an emergency when a loss of power occurs.

Referring to the figures in general, the device can be coupled to an AC input for recharging of the internal battery by use of a charger circuit. A control system determines positioning of a switch for either a jump start output or to a battery reconditioning system for a sulfated battery. The electrical cables are secured to the terminals of vehicle in the conventional manner. The reconditioning mode of the controller can be engaged by pressing and holding the battery status/battery recondition button for 2 seconds. In this mode a beep will sound once every minute and the backlit LCD will display the battery status and voltage indicator, as well as the flashing jump starter icon. The process takes about 24 hours to complete.

In the disclosed embodiment, the device provides 500 Amps for use in jump starting. An internal battery provides the basic functionality and is based upon a rechargeable battery. Battery status is monitored by use of am electronic circuit that employs amplifiers LM 339 for detecting battery voltage and a controller coupled to a centrally located graphic display panel 10 for use in indicating levels of voltage. For instance, four solid bars 12 is used to provide a graphic illustration when the voltage of the battery is greater than 12.8V. Three solid bars provide a graphic illustration when the battery voltage is between 12.4V and 12.8V. Two solid bars indicate when the battery voltage is between 12.0V and 12.4V. One solid bar when the battery is between 11V and 12V. The graphic display panel further depicts a battery icon wherein the bars can be used to fill the volume of the battery to provide indication of the battery lever. The positive and negative terminals of the battery, indicated by “+” and “−” on the graphic display depict polarity connection or reversal. A tire icon 16 is depicted when the air compressor is activated. An engine icon 18 is depicted when the jump starter circuit is activated. A USB icon 20 is depicted when the USB port is available for use and illustrating of the voltage output. The graphic display 22 indicates a pressure reading indicia 24 when the air compressor is activated or voltage indicia 26 when the device is used to charge a battery.

The charging of a vehicle battery is performed by connecting a cable or the like flexible positive connector having a first end to a positive terminal of the device which is referred to as a terminal block and a second end of the cable to a positive terminal of a vehicle mounted battery. Similarly a cable or the like flexible negative connector having a first end is coupled to a negative terminal of the terminal block and a second end of the cable is made available for temporary securement to a negative terminal of a vehicle mounted battery, or more properly, to the grounded chassis of the vehicle. If the cables are attached improperly so that a reverse polarity might accrue, for example attaching a negative connector to the positive terminal of a battery, an alarm buzzer sounds and a red LED warning light illustrates the cross connect.

A battery charger circuit may receive power from an AC source and converted to a DC voltage and charging current for maintaining an internal battery or for use in charging an external battery. The battery charger circuit is coupled to the terminal block wherein the charging voltage and current are delivered through the connectors. A boost charge is provided by a combination of a charge from the battery charger and the internal battery.

A battery reconditioner is used to treat a battery that is failing to hold a charge. Lead and lead oxide are the active materials on a battery plate and react with sulfuric acid to form lead sulfate. The lead sulfate first forms in a finely divided, amorphous state and reverts to lead, lead oxide and sulfuric acid when a battery recharges. As batteries are cycled, the lead sulfate converts to a crystalline form that does not dissolve during recharging. As all the lead is not returned to the battery plates then the capacity of the battery diminishes. Sulfation can be avoided if the battery is fully recharged immediately after use. Desulfation takes place by initiating power to the reconditioning circuit by closing switch SW1 providing power from the internal battery BT1 or the charging circuit to the battery recondition circuit.

Transistors Q11 and Q12 provide a charged oscillator pulse by cross connecting the capacitors C7 and C8. The pulse is delivered through a series/parallel combination of transistors Q10 directing through transistors Q6 and Q7 with discharge into capacitors C5 and C9 and then through capacitor C6 and coupling to the positive connector. Switch 105 initiates the battery reconditioner.

The apparatus in formed in a stylized housing 100 having a handle 101 for ease of portability and a panel 102 including accessories outputs namely the USB port (USB1) 104 that is electrically coupled to the internal battery BT1. The USB port has a low voltage protection circuit to prevent operation of the USB port at voltages below 5 volts. The output voltage level can be made adjustable, however, in the preferred embodiment a 5 volt level is maintained by use of step-down transformer L1 with the signal stabilized by capacitors C3 and C4.

An air compressor provides an accessory for use in filling of a low tire or for filling of other inflatable objects. Compressor M1 is operated by closing of SW4 106 to complete a circuit for providing power the battery or an AC source to the compressor. The housing 100 includes a storage receptacle 113 for holding of a length of air hose. One end of the air hose is coupled to the air compressor and a second end include a universal air chuck for attachment to conventional air filling ports.

An LED area light LED6 108 is electrically coupled to the internal battery for use in illuminating low level light conditions. The light is swivel mounted allowing for area or focused lighting. Switch SW2 110 is manually initiated to initiate light operation. An auxiliary DC output P1 112 is provided allowing the coupling of 12V accessories to the internal battery by use of a conventional cigarette style plug.

The digital display screen provides voltage, when in a battery testing mode, or air pressure when the air compressor switch 102 is in operation. Jumper cables 116 and 136 provide a reverse polarity protected coupler for use in jump starting an external battery. Integrated clamp holder provide ease of storage for the positive battery clamp 116, cable tabs 120 & 122 allow for the wrapping of the cable without damage. Clamp holder 130 is also integrated with the housing to hold the negative clamp 136 with wrap tabs 132 & 134 for storage of the cable in a compact area without damaging the cable.

It is to be understood that while I have illustrated and described certain forms of my invention, it is not to be limited to the specific forms or arrangement of parts herein described and shown. It will be apparent to those skilled in the art that various changes may be made without departing from the scope of the invention and the invention is not to be considered limited to what is shown in the drawings and described in the specification.

What is claimed is:

1. A multi-purpose battery jump starter and reconditioner comprising:
a portable housing; an internal battery;
means for measuring voltage of said internal battery and graphically displaying said measured voltage;
a battery charger circuit means available for receipt of AC power and converting to a DC voltage, said battery charger circuit means constructed and arranged to provide a charging current to said internal battery;
a battery booster means coupled to said internal battery; starting energy to the vehicle battery through the positive and negative connectors;
a battery reconditioner means provides an oscillating electrical pulse by use of transistor based circuit having a cross fed capacitor with bipolar transistors constructed and arranged to provide energy at a level that can desulfanate a lead acid battery;
a flexible positive connector having a first end releasably coupled to a positive terminal of said internal battery and a second end available for temporary securement to a positive terminal of a vehicle mounted battery;
a flexible negative connector having a first end releasably coupled to a negative terminal of said internal battery and a second end available for temporary securement to a negative terminal of a vehicle mounted battery;
a controller means for selecting either said battery booster means or said battery reconditioner means; and
a battery switching means for selecting between said internal battery and said battery charger.

2. The multi-purpose battery jump starter and reconditioner according to claim 1 including a USB port electrically coupled to said internal battery, said USB port having a circuit means for adjusting an output voltage level, said output voltage level graphically displayed on said digital screen.

3. The multi-purpose battery jump starter and reconditioner according to claim 1 wherein said USB port circuit means includes low voltage protection.

4. The multi-purpose battery jump starter and reconditioner according to claim 1 including an air compressor system electrically coupled to said internal battery, said air compressor securable to nozzles for use in inflating objects.

5. The multi-purpose battery jump starter and reconditioner according to claim 1 including a means for alarming if said positive connector is coupled to a negative terminal.

6. The multi-purpose battery jump starter and reconditioner according to claim 1 including an LED area light electrically coupled to said internal battery, said area light available for illuminating low level light environments.

7. The multi-purpose battery jump starter and reconditioner according to claim 1 including an auxiliary DC output is provided from the internal battery.

8. The multi-purpose battery jump starter and reconditioner according to claim 1 wherein a boost charge is provided by a combination of a charge from said battery charger and from said internal battery.

9. The multi-purpose battery jump starter and reconditioner according to claim 1 wherein said graphic display indicates four solid bars when the voltage is greater than 12.8V, three solid bars when the battery voltage is between 12.4V and 12.8V; two solid bars when the battery voltage is between 12.0V and 12.4V; and one solid bar when the battery is between 11V and 12V.
